(19) United States
(12) Patent Application Publication
(10) Pub. No.: US 2009/0155635 A1
(43) Pub. Date: Jun. 18, 2009

(54) METHOD OF ACTIVATING MEMBRANE ELECTRODE ASSEMBLY (PEM) OF POLYMER ELECTROLYTE MEMBRANE FUEL CELL (PEMFC) USING CYCLIC VOLTAMMETRY (CV)

(75) Inventors: Ki Yun Cho, Seoul (KR); Ki Sub Lee, Seoul (KR); Il Hee Cho, Seoul (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/276,798

(22) Filed: Nov. 24, 2008

(30) Foreign Application Priority Data
Dec. 12, 2007 (KR) 10-2007-0128800

(51) Int. Cl. H01M 8/00

(52) U.S. Cl. 429/13

(57) ABSTRACT

The present invention relates to a method of activating membrane electrode assemblies of polymer electrolyte membrane fuel cells of a fuel cell stack for a vehicle comprising: supplying a humidified gas to a fuel cell so as to hydrate an electrolyte membrane and an electrolyte of electrodes of the fuel cell; and performing a cyclic voltammetry process so as to activate the layers of the electrodes.

### CROSS-REFERENCE TO RELATED APPLICATION

This application claims the benefit under 35 U.S.C. §119(a) of Korean Patent Application No. 10-2007-0128860 filed on Dec. 12, 2007, the entire contents of which are incorporated herein by reference.

### BACKGROUND

(a) Technical Field

The present invention relates to a method of activating membrane electrode assemblies of polymer electrolyte membrane fuel cells for a vehicle using cyclic voltammetry.

(b) Background Art

In general, a polymer electrolyte membrane fuel cell (PEMFC) has high energy efficiency, current density and power density, a short start time and a rapid response to a load change as compared to the other types of fuel cells. Moreover, it is less susceptible to a variation in pressure of a reaction gas and can output a power of various ranges. For these reasons, it can be applied to various fields including a power source of a zero-emission vehicle (ZEV), a self-generator, a portable power, an army application power and the like.

A PEMFC is a device which allows hydrogen and oxygen to react with each other electrochemically to produce water and generate electricity.

Hydrogen supplied to the anode of a PEMFC is decomposed into protons (H⁺) and electrons (e−) by a catalyst. The protons (H⁺) migrate from the anode to the cathode through a polymer electrolyte membrane as a proton exchange membrane.

At this time, oxygen supplied to the cathode reacts with the electrons (e−) transported from the anode to the cathode through an external conductor and the protons (H⁺) migrated from the anode to the cathode through the polymer electrolyte membrane to produce water and generate electric energy.

In this case, a theoretical electric potential is 1.23 V, and the electrode reaction of the PEMFC is represented by the following reaction scheme.

Anode: H₂→2H⁺+2e−

Cathode: ½O₂+2H⁺+2e−→H₂O

Overall: H₂+½O₂→H₂O+Electrical energy+heat energy

Generally, the electrode of the fuel cell is fabricated by mixing a proton-translocating membrane material such as Nafion and a catalyst such as platinum.

After a membrane electrode assembly (MEA) is fabricated, catalyst activity is deteriorated in the electrochemical reaction at the time of an initial operation for several reasons including the following: (i) a reactant does not reach the catalyst due to blockage of transport passage; (ii) proton-translocating membrane material formed with a three-phase boundary (TPB) is hard to be hydrated at the time of the initial operation; (iii) continuous translocation of the protons and electrons is not secured; (iv) impurities introduced during the fabrication of the electrode reduces the catalyst activity; (v) an oxidation layer formed on the catalyst reduces the catalyst activity; and (vi) the catalyst has an unoptimized catalyst electron structure.

Thus, activation (preconditioning or break-in) of an MEA is required to maximally secure the performance of the fuel cell. The MEA activation can be made by, for example, (i) activating a catalyst which does not participate in the reaction, (ii) sufficiently hydrating the electrolyte membrane and electrolyte included in the electrodes to secure ion transport passage, (iii) removing a catalyst-poisoning material, (iv) removing an unnecessary oxidation layer surrounding the catalyst, optimizing the catalyst electron structure for fuel cell reaction, or any combination thereof.

The MEA activation, however, may take several hours or days depending on operation conditions. Also, a fuel cell may not be operated with its full performance due to insufficient activation. The insufficient activation can lower productivity in the mass-production of the fuel cell, can cause a significant amount of hydrogen to be consumed, thereby increasing manufacturing cost of the fuel cell stack, and can lower the overall fuel cell performance. In addition, measuring the maximum cell performance of MEA may take a long time or the maximum cell performance of MEA may be erroneously measured.

To date, activation of a fuel cell has been conducted in a variety of different methods depending on fuel cell manufacturers, but most of the methods involve operation of the fuel cell for a long time under a given voltage by which a catalyst which does not participate in the reaction can be activated and an electrolyte membrane and electrolyte included in the electrode of the fuel cell can be sufficiently hydrated.

For example, the Japanese Patent Application No. 2003-143126 assigned to AISIN SEIKI Co., Ltd. discloses a method of activating a solid polymer fuel cell in which the fuel cell is left to stand for a long time at a low voltage up to a point where the stack performance is no longer improved. This method, however, takes a very long time to exhibit the sovereign performance of the fuel cell.

As shown in FIG. 1, Korean Patent Application No. 2005-120743 assigned to Hyundai Motor Company discloses a activation method of a polymer electrolyte membrane fuel cell adopting a step voltage-based operation in which a voltage cycle is applied to a fuel cell stack and activation is performed at a high relative humidity and temperature so as to shorten the activation time to four hours on average. Even with this method, it still may take eight or more hours for activation depending on the condition.

There is thus a need for the development of an activation method that can improve the activity of a catalyst by removal of impurities included in the catalyst, removal of an unnecessary oxidation layer surrounding the catalyst, and optimization of the catalyst electron structure, thereby ultimately achieving reduction in the activation time of the catalyst.

The information disclosed in this Background section is only for enhancement of understanding of the background of the invention and should not be taken as an acknowledgment or any form of suggestion that this information forms the prior art that is already known to a person skilled in that art.

### SUMMARY OF THE DISCLOSURE

The present invention has been made in an effort to solve the above problems occurring in the prior art, and it is an object of the present invention to provide an accelerated activation method of a membrane electrode assembly (MEA) of a polymer electrolyte membrane fuel cell (PEMFC) using a cyclic voltammetry (CV), which can improve the performance of the MEA and stabilize the cell performance within a short time.

In one aspect, the present invention provides a method of activating membrane electrode assemblies of polymer electrolyte membrane fuel cells of a fuel cell stack for a vehicle, the method comprising: (a) a first step of supplying a humidified gas to a fuel cell so as to hydrate an electrolyte membrane and an electrolyte of the electrodes of the fuel cell; and (b) a second step of performing a cyclic voltammetry (CV) process so as to activate the layers of the electrodes.

Preferably, in the first step, only the humidified gas may be supplied to the fuel cell without using an electronic load and an application device. In the second step, the CV process may be performed in the range of 0V to 3V. Preferably, the CV process may be performed continuously for the entire round of CV cycles without any break. Also preferably, it may be performed in a plurality of sequential steps, in which case each of the steps may include a predetermined number of round of CV cycles, a break or breaks with an appropriate interval or intervals may be set in between some or all of the steps, and humidified gas may be supplied to the fuel cell between some or all of the steps. Suitably, the humidified gas may be supplied to the fuel cell at one or more intervals during one or more of the steps of the CV process.

Preferably, the humidified gas of the first step may comprise nitrogen, oxygen, hydrogen, inert gas and the like.

Also preferably, in an embodiment, the humidified gas may supply hydrogen to the anode and inert gas such as nitrogen or oxygen to the cathode. Preferably, unit cells of the fuel cell stack may be connected in parallel or in series with each other.

In another aspect, the present invention provides a method of activating membrane electrode assemblies of polymer electrolyte membrane fuel cells of a fuel cell stack for a vehicle, the method comprising: (a) a first step of performing a cyclic voltammetry (CV) process so as to activate the layers of the electrodes of the a fuel cell; and (b) a second step of supplying a humidified gas to the fuel cell so as to hydrate an electrolyte membrane and an electrolyte of the electrodes.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

FIG. 1 is a graph showing an activation evaluation method using a step voltage and an evaluation result;

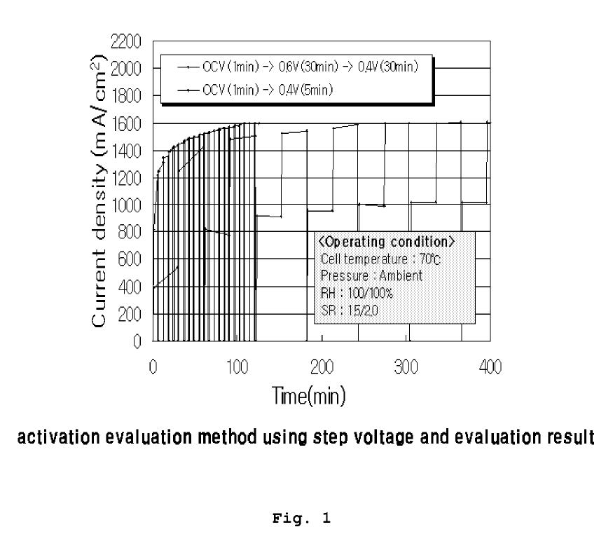

FIG. 2 is a graph showing a fuel cell performance when only the step of supplying a humidification gas is performed and when the number of CV cycles is increased;

FIG. 3 is a graph showing a variation in electrode activation according to an increase in the number of CV cycles;

FIG. 4 is a graph showing a comparison between the performance of a fuel cell subjected to the CV-based activation process and the performance of a fuel cell subjected to both a step voltage-based activation process and the CV-based activation process; and

FIG. 5 is a graph of the performances of a fuel cell subjected to a step voltage-based activation process for 6 hours followed by the CV-based activation process.

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

A fuel cell is a device which allows hydrogen to be supplied to an anode and oxygen to be supplied to a cathode to produce an electrochemical reaction within the fuel cell, thereby generating a high-efficiency electric energy and water by the reaction.

The electrochemical reaction occurs in catalyst layers inside the fuel cell to generate protons and electrons. The generated protons are transported from an anode to a cathode inside the fuel cell through an electrolyte and an electrolyte membrane between the catalyst layers, and the electrons are transported from the anode to the cathode through a catalyst, a gas diffusion layer and a separating plate.

But, since the protons are emigrated from the anode to the cathode through the electrolyte and the electrolyte membrane while passing through water existing in the electrolyte membrane, the electrolyte and the electrolyte membrane between the catalysts is required sufficiently to be hydrated in order for the fuel cell to exhibit a better performance.

In addition, a reaction gas is required to smoothly reach a catalyst layer in order to produce the electrochemical reaction.

Besides, in order to achieve the maximum cell performance, it is required to remove an unnecessary oxidation layer and impurities which may be produced in the catalyst layer during the fabrication and storage of the fuel cell, and transform the catalyst electron structure into a catalyst electron structure suitable for the fuel cell reaction.

The conditions needed for the activation are as follows: 1) to activate a catalyst which does not participate in the reaction, 2) to secure a proton passageway through sufficient hydration of the electrolyte membrane and the electrolyte included in the electrodes, 3) to remove a catalyst-poisoning material, 4) to remove an unnecessary oxidation layer surrounding the catalyst, and 5) to control the catalyst electron structure so as to be suitable for the fuel cell reaction.

The present invention provides an activation method of an MEA of a fuel cell for achieving an optimal fuel cell performance, which can satisfy the above conditions.

The present invention suggests a method for activating an MEA, which can stably measure the maximum cell performance of MEAs and fuel cell stack thereof within a short time (e.g., about two and a half hours).

As discussed above, one aspect of the present invention provides a method of activating membrane electrode assemblies of polymer electrolyte membrane fuel cells of a fuel cell stack for a vehicle, the method comprising: (a) a first step of supplying a humidified gas to a fuel cell so as to hydrate an electrolyte membrane and an electrolyte of the electrodes of the fuel cell; and (b) a second step of performing a cyclic voltammetry (CV) process so as to activate the layers of the electrodes.

In an embodiment, the method may comprise: (a) a first step of supplying a humidified nitrogen to a fuel cell so as to hydrate an electrolyte membrane and an electrolyte of the electrodes of the fuel cell; and (b) a second step of performing a cyclic voltammetry (CV) process so as to activate the layers of the electrodes.

In the first step, the humidified nitrogen allows water to be supplied to the electrolyte membrane and the electrolyte of the electrodes. Owing to the supplied water, a proton passageway of the electrolyte membrane and the electrolyte of the electrodes is secured so that protons generated from the anode can be smoothly transported to the cathode therethrough.

In case of supplying the humidified nitrogen (or the humidified gas) in the first step, neither an electronic load nor an application device is involved.

Preferably, the humidified gas of the first step may include one selected from the group consisting of nitrogen, oxygen, hydrogen and inert gas.

After the humidification process is performed, to remove impurities and an unnecessary oxidation layer and control the catalyst electron structure to be suitable for the fuel cell reaction, a CV process is performed by applying a voltage cycle or cycles in a range of from 0V to 3V.

Preferably, in the CV process, a humidified gas may be supplied. The humidified gas supplies hydrogen to the anode and inert gas such as nitrogen or oxygen to the cathode. A certain amount of energy is required to be supplied in order to remove the impurities and the unnecessary oxidation layer. Conventionally, heat energy with 300° C. or higher is used for the purpose. However, such a high temperature decomposes the electrolyte membrane and the electrolyte of the electrodes. Thus, instead of heat energy, electrochemical energy is used in the present invention.

More specifically, an oxidation reaction should be performed to remove the impurities while a reduction reaction should be performed to remove unnecessary oxidation layer. That is, a higher potential is required to remove the impurities and a lower potential is required to remove the unnecessary oxidation layer. This can be achieved by a CV process. Preferably, in the present invention, a cycle voltage is supplied in a specific voltage range of from 0V to 3V.

More particularly, where a voltage is boosted from 0V to 1V or higher, since the oxidation potential is more than 1V, the impurities are smoothly removed. In the meantime, where a voltage is lowered from 1V or higher to 0V, since the reduction potential is sufficiently low, i.e., around 0V, the unnecessary oxidation layer is smoothly removed.

Preferably, the CV process may be performed in various ways in the range of from 0V to 3V. For example, the CV process may be performed continuously for the entire round of CV cycles without any break. Alternatively, it may be performed in a plurality of sequential steps, in which case each of the steps may include a predetermined number of round of CV cycles, a break or breaks with an appropriate interval or intervals may be set in between some or all of the steps, and humidified gas may be supplied to the fuel cell between some or all of the steps.

When the CV cycle is applied, hydrogen can be supplied to the anode and inert gas such as nitrogen can be supplied to the cathode.

In the prior art step voltage method, hydrogen is injected into an anode and inert gas is injected into a cathode to produce electric current. However, the step voltage method has a problem that it cannot easily remove the oxidation layer since the overall voltage of 0.4V (reduction potential) is not sufficiently low. By contrast, the CV process according to the present invention can easily remove the oxidation layer due to its sufficiently low reduction potential. Besides, the step voltage method also has a problem that it cannot easily remove the impurities since the oxidation potential is lower than a maximum voltage of 1V which is the open-circuit voltage (OCV) of the MEA.

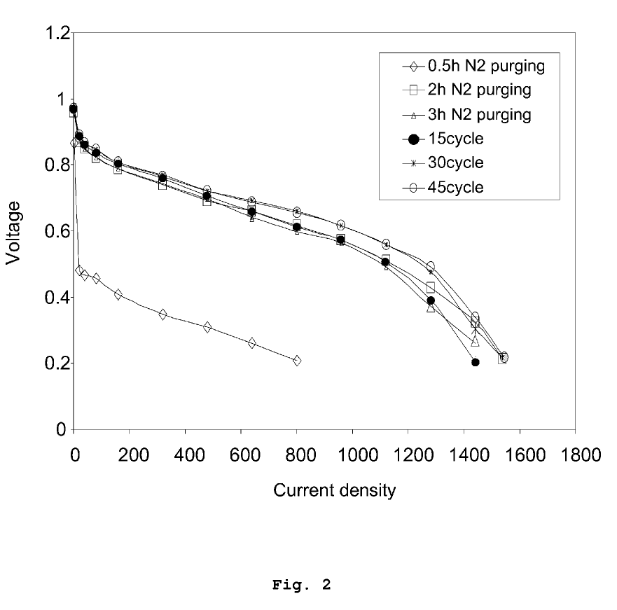

FIG. 2 is a graph showing the performance of a fuel cell when only the step of supplying a humidification gas is performed and when the number of CV cycles is increased.

The fuel cell performance was measured after humidification of the electrolyte for 30 minutes. The fuel cell performance was greatly degraded due to insufficient humidification. The fuel cell performance measured after humidification of the electrolyte for two hours was nearly similar to that measured after humidification of the electrolyte for three hours. This result means that only humidification is not enough to increase the fuel cell performance, and activation of an electrode catalyst is indispensably required.

It can be seen from FIG. 2 that the fuel cell performance increases and then reaches a certain value depending on an increase in the number of CV cycles. A preferable number of CV cycles for CV activation is 30 to 45 on average.

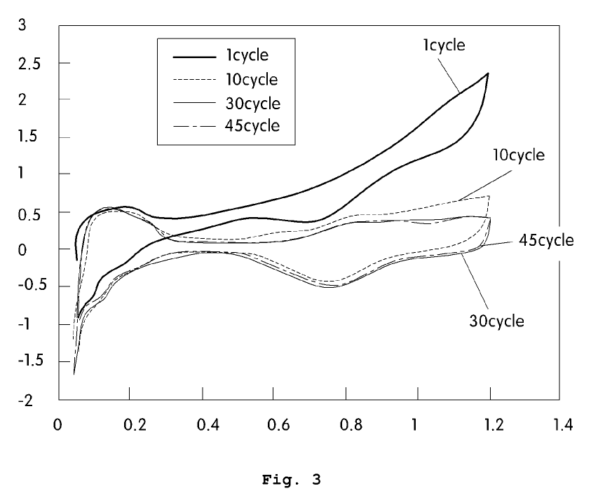

In FIG. 3, there is shown a variation in electrode activation according to an increase in the number of CV cycles.

When the CV cycle was not applied, a current increased depending on an increase of voltage value in a voltage range between 0.2V and 0.6V. Without intending to limit the theory, it is contemplated that this occurred because hydration occurs at a catalyst site by virtue of water produced by a catalyst reaction due to the CV cycle in an early stage, leading to a reduction in resistance at the electrodes. In addition, a variation in a Pt-oxide layer occurred in a voltage range between 0.8V and 1.2V due to the CV cycle. Without intending to limit the theory, it is contemplated that this occurred because of the removal of an unnecessary Pt-oxide layer and the impurities.

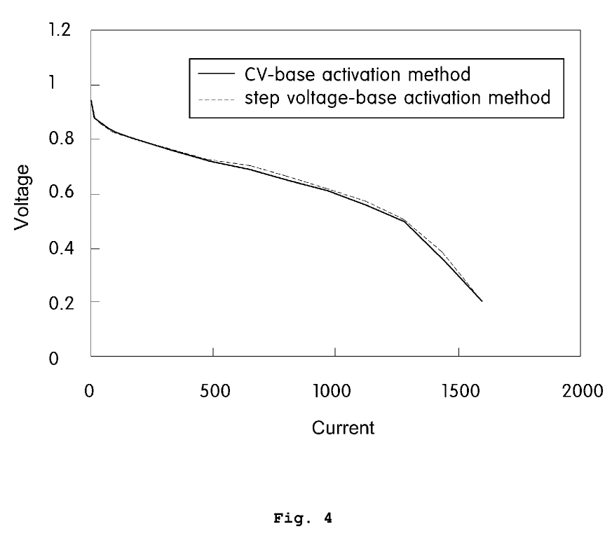

FIG. 4 is a graph showing a comparison between the performance of a fuel cell subjected to the above-described CV-based activation process and the performance of a fuel cell subjected to both the above-described step voltage-based activation process and the above-described CV-based activation process.

The performance of the fuel cell subjected to the CV activation process was similar to that of the fuel cell subjected to the step voltage-based activation process for four hours in addition to the CV activation process. This means that the MEA activated by the CV-based activation method exhibits the maximum cell performance.

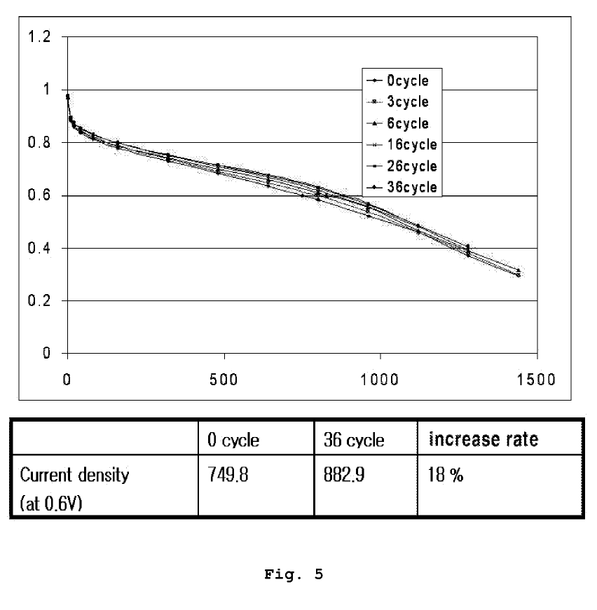

FIG. 5 is a graph of the performances of a fuel cell subjected to the step voltage-based activation process for 6 hours followed by the CV-based activation process.

The performance of the fuel cell activated by the step voltage-based activation method for six hours was 749.8 mW/cm². On the other hand, in case where the fuel cell was additionally activated by the CV-based activation method besides the step voltage-based activation method, the performance of the fuel cell increased gradually depending on an increase in the number of CV cycles. Subsequently, when the number of CV cycles was 36, the performance of the fuel cell increased to 882.9 mW/cm² by 18%.

As can be seen from FIGS. 4 and 5 that only the step voltage-based activation method performed for a long time is not enough to activate the fuel cell, and the CV-based activation method achieves the maximum cell performance within a short time.

Although the methods including a first step of humidification and a second step of CV process are described in the embodiments, a method including a first step of CV process and a second step of humidification is also within the scope of the present invention. Although performance test results are shown herein only with regard to the methods of humidification-then-CV process, similar performance test results were obtained for the method of CV process-then-humidification.

The present activation methods provide various advantages including the following. The time taken to activate the fuel cell can be reduced, and the costs for activation of fuel cell stacks can be reduced.

The invention has been described in detain with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of activating membrane electrode assemblies of polymer electrolyte membrane fuel cells of a fuel cell stack for a vehicle, the method comprising the steps of:
(a) supplying a humidified gas to a fuel cell so as to hydrate an electrolyte membrane and an electrolyte of electrodes of the fuel cell; and
(b) performing a cyclic voltammetry (CV) process so as to activate the layers of the electrodes.

2. The method of claim 1, wherein in step (a), in supplying the humidified gas, neither an electronic load nor an application device is involved.

3. The method of claim 1, wherein the CV process in step (b) is performed by applying at least one CV cycle in a range of 0V to 3V.

4. The method of claim 3, wherein the CV process in step (b) may be performed through a plurality of sequential steps, in which case each of the steps may include a predetermined number of round of CV cycles, a break or breaks with an appropriate interval or intervals may be set in between some or all of the steps, and humidified gas may be supplied to the fuel cell between some or all of the steps before initiating the CV cycle in the next step.

5. The method of claim 3, wherein the entire rounds of CV cycles of the CV process in step (b) may be performed continuously without any break.

6. The method of claim 4, wherein the humidified gas is supplied to the fuel cell at one or more intervals during one or more of the steps of the CV process.

7. The method of claim 1, wherein the humidified gas in step (a) comprises nitrogen, oxygen, hydrogen, and inert gas.

8. The method of claim 1, wherein the humidified gas supplies hydrogen to an anode and inert gas or oxygen to a cathode when the CV cycle is applied.

9. The method of claim 1, wherein a plurality of unit cells, which build up to form a stack that is activated by the activation of CV, may be connected in parallel or in series with each other.

10. A method of activating membrane electrode assemblies of polymer electrolyte membrane fuel cells of a fuel cell stack for a vehicle, the method comprising: (a) a first step of performing a cyclic voltammetry (CV) process so as to activate the layers of the electrodes of the a fuel cell; and (b) a second step of supplying a humidified gas to the fuel cell so as to hydrate an electrolyte membrane and an electrolyte of the electrodes.
